(19) United States
(12) Patent Application Publication
(10) Pub. No.: US 2011/0189360 A1
(43) Pub. Date: Aug. 4, 2011

(54) Method to Increase Solubility Limit of Rebaudioside D in an Aqueous Solution

(75) Inventors: Harold S. Yoo, Old Tappan, NJ (US); Corey Wintamute, New York, NY (US)

(73) Assignee: PepsiCo, Inc., Purchase, NY (US)

(21) Appl. No.: 12/700,223

(22) Filed: Feb. 4, 2010

(51) Int. Cl. A23L 2/60; A23L 2/52; A23L 2/68; A23L 1/236

(52) U.S. Cl. 426/330.3; 426/330

(57) ABSTRACT

Low pH beverage products which include rebaudioside D are provided. Methods of making low pH beverage products which include rebaudioside D are provided. Methods of making syrups which include rebaudioside D are provided. Methods of making supersaturated solutions of rebaudioside D are provided.

### FIELD OF THE INVENTION

This invention relates to methods for making supersaturated solutions of rebaudioside D, as well as low pH beverages, syrups for use in low pH beverages, and other low pH beverage products, such as low pH beverage concentrates, etc. that include rebaudioside D, optionally provided in a supersaturated solution. In particular, this invention relates to low pH beverages that include rebaudioside D and are suitable to meet market demand for alternative nutritional characteristics or flavor profiles in beverages.

### BACKGROUND

It has long been known to produce beverages of various formulations. Improved and new formulations are desirable to meet changing market demands. In particular, there is perceived market demand for beverages having alternative nutritional characteristics, including, for example, alternative calorie content. Also, there is perceived market demand for beverages having alternative flavor profiles, including good taste and mouthfeel. In addition, there is consumer interest in beverages and other beverage products, such as beverage concentrates, etc. whose formulations make greater use of natural ingredients, that is, ingredients distilled, extracted, concentrated or similarly obtained from harvested plants and other naturally occurring sources, with limited or no further processing.

The development of new beverage formulations, for example, new beverage formulations employing alternative sweeteners, flavorants, flavor enhancing agents and the like, presents challenges in addressing associated bitterness and/or other off-tastes. In addition, such challenges typically are presented in new beverage formulations developed for alternative nutritional and/or flavor profiles. Also, there is need for new beverage formulations which can satisfactorily meet the combination of objectives including nutritional characteristics, flavor, shelf life, and other objectives.

Development of new beverage formulations has faced obstacles. For example, U.S. Pat. No. 4,956,191 suggests that carbonated beverages which contain blends of saccharin or the Stevia extract with aspartame tend to be less organoleptically pleasing than those containing sugar. Also, because of their low solubility, certain high potency sweeteners are not suitable for use as the sweetener, e.g., as the sole sweetener, in a typical 5-to-1 throw beverage syrup. A given volume of 5-to-1 throw beverage syrup typically will be diluted with five times that volume of water or carbonated water to make the ready-to-drink beverage. Thus, the syrup will have beverage ingredients at six times the final, i.e., ready-to-drink beverage concentration. If a sweetener is not sufficiently soluble in the syrup to provide the desired sweetness level in the finished beverage, it will be difficult or impossible to use as the sweetener for the syrup.

It is therefore an object of the present invention to provide beverages and other beverage products. It is an object of at least certain embodiments of the invention (that is, not necessarily all embodiments of the invention) to provide beverages and other beverage products having desirable taste properties. It is an object of at least certain (but not necessarily all) embodiments of the invention to provide beverages and other beverage products having improved formulations. These and other objects, features and advantages of the invention or of certain embodiments of the invention will be apparent to those skilled in the art from the following disclosure and description of exemplary embodiments.

### SUMMARY

The present invention relates to methods for providing supersaturated solutions of rebaudioside D. The present invention also relates to methods for preparing a syrup including rebaudioside D for use in low pH beverages. The present invention further relates to methods for providing ready-to-drink, low pH beverage products including rebaudioside D.

In accordance with a first aspect, a method of preparing a supersaturated solution of rebaudioside D is provided comprising the steps of mixing rebaudioside D in aqueous liquid with heating to an elevated temperature to form a heated rebaudioside D solution having a pH of at least 7.0, cooling the rebaudioside D solution to form a supersaturated solution of rebaudioside D, adding at least one beverage ingredient to the supersaturated solution of rebaudioside D to form a beverage product precursor having a pH of at least 7.0, and acidulating the beverage product precursor to a pH of less than 4.0.

In certain exemplary embodiments, the neutral pH liquid is water. In certain exemplary embodiments, the rebaudioside D solution is at least 80° C. In certain exemplary embodiments, the rebaudioside D solution is between about 75° C. and about 90° C. In certain exemplary embodiments, the rebaudioside D solution is between about 80° C. and about 85° C. In certain exemplary embodiments, the mixing is at least in part concurrent with the heating. In certain exemplary embodiments, the mixing is high shear stirring. In certain exemplary embodiments, the concentration of rebaudioside D in the supersaturated solution of rebaudioside D is at least about 500 parts per million (ppm). In certain exemplary embodiments, the concentration of rebaudioside D in the supersaturated solution of rebaudioside D is at least about 3000 ppm. In certain exemplary embodiments, the rebaudioside D concentration is at least about 90% of the solubility limit for rebaudioside D in water at the elevated temperature. In certain exemplary embodiments, the step of acidulating the beverage product precursor comprises adding at least one edible acid to the beverage product precursor. In certain exemplary embodiments, the at least one edible acid includes one or more of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them. In certain exemplary embodiments, the step of carbonating the beverage product precursor is provided. In certain exemplary embodiments, the step of cooling is performed at a rate of about 5° C./hour.

In accordance with another aspect, method of preparing a syrup is provided, including the steps of mixing rebaudioside D in aqueous liquid with heating to an elevated temperature to form a heated rebaudioside D solution having a pH of at least 7.0, cooling the rebaudioside D solution to form a supersaturated solution of rebaudioside D, adding at least one syrup ingredient to the supersaturated solution of rebaudioside D to form a syrup precursor having a pH of at least 7.0, and acidulating the syrup precursor to a pH of less than 4.0.

In certain exemplary embodiments, the rebaudioside D solution is at least 80° C. In certain exemplary embodiments, the rebaudioside D solution is between about 75° C. and about 90° C. In certain exemplary embodiments, the rebaudioside D solution is between about 80° C. and about 85° C. In certain exemplary embodiments, the mixing is at least in part concurrent with the heating. In certain exemplary embodiments, the mixing comprises high shear stirring. In certain exemplary embodiments, the concentration of rebaudioside D in the syrup is at least about 3000 ppm. In certain exemplary embodiments, the step of acidulating the syrup precursor comprises adding at least one edible acid to the beverage product precursor. In certain exemplary embodiments, the at least one edible acid includes one or more of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them. In certain exemplary embodiments, the step of cooling is performed at a rate of about 5° C./hour. In certain exemplary embodiments, the at least one syrup ingredient is selected from the group consisting of a flavorant, a colorant, a preservative and mixtures of any of them.

In accordance with another aspect, method of preparing a low pH beverage is provided, including the steps of mixing rebaudioside D in aqueous liquid with heating to an elevated temperature to form a heated rebaudioside D solution having a pH of at least 7.0, cooling the rebaudioside D solution to form a supersaturated solution of rebaudioside D, adding multiple beverage ingredients to the supersaturated solution of rebaudioside D to form a beverage product precursor having a pH of at least 7.0, acidulating the beverage product precursor to a pH less than 4.0, and diluting the beverage product precursor to form a ready-to-drink, low pH beverage.

In certain exemplary embodiments, the rebaudioside D solution is at least 80° C. In certain exemplary embodiments, the rebaudioside D solution is between about 75° C. and about 90° C. In certain exemplary embodiments, the rebaudioside D solution is between about 80° C. and about 85° C. In certain exemplary embodiments, the mixing is at least in part concurrent with the heating. In certain exemplary embodiments, the mixing comprises high shear stirring. In certain exemplary embodiments, the concentration of rebaudioside D in the ready-to-drink, low pH beverage is at least about 400 ppm. In certain exemplary embodiments, the concentration of rebaudioside D in the ready-to-drink, low pH beverage is between about 450 ppm and about 500 ppm. In certain exemplary embodiments, the step of acidulating the beverage product precursor comprises adding at least one edible acid to the beverage product precursor. In certain exemplary embodiments, the at least one edible acid includes one or more of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them. In certain exemplary embodiments, the methods further include the step of carbonating the low pH beverage to produce a carbonated, ready-to-drink, low pH beverage. In certain exemplary embodiments, the methods further include the step of filling multiple containers with the low pH beverage. In certain exemplary embodiments, the methods further include the step of filling multiple containers with the carbonated, low pH beverage. In certain exemplary embodiments, the ready-to-drink, low pH beverage is a carbonated soft drink, a non-carbonated soft drink or a fountain drink.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### BRIEF DESCRIPTION OF THE DRAWING

The foregoing and other features and advantages of the present invention will be more fully understood from the following detailed description of illustrative embodiments taken in conjunction with the accompanying drawing in which:

FIG. 1 depicts a differential scanning calorimetry (DSC) thermal energy graph for rebaudioside D.

### DETAILED DESCRIPTION OF CERTAIN EXEMPLARY EMBODIMENTS

Certain aspects of the present invention are based on the surprising discovery that the supersaturated solution of rebaudioside D having a low pH can be made by a method in which rebaudioside D is combined with a neutral or high pH liquid such as water, the rebaudioside D and the neutral or high pH liquid are heated with stirring, and the rebaudioside and the neutral or high pH liquid are slowly cooled to form a supersaturated solution of rebaudioside D.

As used herein, the term “saturated” refers to the point of maximum concentration at which a solution of a substance (e.g., a rebaudioside D solution) can dissolve no more of that substance. The saturation point of a substance depends on the temperature of the liquid the substance is to be dissolved in, as well as the chemical natures of the liquid and the substance involved (e.g., the water and/or the rebaudioside D).

As used herein, the term “supersaturated” refers to a solution that contains more of a dissolved material (e.g., rebaudioside D) than a saturated solution. Supersaturated solutions are typically achieved when one or more conditions of a saturated solution is changed, such as, e.g., temperature, volume (e.g., by evaporation), pressure or the like. Certain exemplary embodiments of the methods disclosed here comprise forming at elevated temperature (e.g., at least 70° C., 75° C., 80° C., 85° C. or 90° C., 95° C., 100° C. or more, or between about 60° C. and 110° C., between about 65° C. and 100° C., between about 70° C. and 95° C., between about 75° C. and 95° C., between about 75° C. and 90° C., between about 80° C. and 90° or between about 80° C. and 85° C.) supersaturated solutions of rebaudioside D at concentrations of at least about 250 parts per million (ppm), at least about 500 ppm, at least about 1000 ppm, at least about 1500 ppm, at least about 2000 ppm, at least about 2500 ppm, or at least about 3000 ppm. In certain exemplary embodiments, the rebaudioside D concentration is at least 50%, 55%, 60%, 65%, 70%, 75%, 80%, 85%, 90%, 91%, 92%, 93%, 94%, 95%, 96%, 97%, 98%, 99% or more of the solubility limit for rebaudioside D in a particular liquid (e.g., water) at a particular elevated temperature. Solutions referenced to as supersaturated both here and in the appended claims are solutions in which the concentration of rebaudioside D is higher than that achieved with heating and higher than that can be dissolved without heating.

As used herein, the term “solubility limit” refers to the maximum concentration of a material (e.g., rebaudioside D) dissolvable in solvent (e.g., water) at a specific physical parameter, e.g., a specific temperature, volume, pressure or the like.

As used herein, the terms “cooled” and “slowly cooled” refer to a rate of cooling of less than about 40° C. per hour, less than about 30° C. per hour, less than about 20° C. per hour, less than about 15° C. per hour or less than about 10° C. per hour. In certain exemplary embodiments, the rate of cooling is between about 40° C. per hour and about 2° C. per hour, between about 30° C. per hour and about 3° C. per hour between about 20° C. per hour and about 5° C. per hour. In certain exemplary embodiments, the rate of cooling is at about 1° C. per hour, 2° C. per hour, 3° C. per hour, 4° C. per hour, 5° C. per hour, 6° C. per hour, 7° C. per hour, 8° C. per hour, 9° C. per hour, 10° C. per hour, 11° C. per hour, 12° C. per hour, 13° C. per hour, 14° C. per hour, 15° C. per hour, 16° C. per hour, 17° C. per hour, 18° C. per hour, 19° C. per hour or at about 20° C. per hour.

pH is a measure of the acidity or basicity of a solution. As used herein, the term “low pH” refers to an acidic pH in the range of below about 1 to about 6. In certain exemplary embodiments, a low pH solution or a low pH beverage product has a pH in the range of about 2.0 to 5.0, about 2.5 to 4.0, about 2.8 to 3.3 or about 3.0 to 3.2. As used herein, the term “high pH” refers to a basic pH in the range of about 8 to about 14. As used herein, the term “neutral pH” refers to a pH of about 7 (e.g., from about 6.5 to about 7.5).

Certain aspects of the present invention pertain to stirring the liquids, beverages, beverage products and various other components described herein. The term “mixing,” as used herein includes, but is not limited to, beating, blending, stirring, high shear stirring, low shear stirring, whipping, folding in, sonicating, sifting, pureeing, and the like.

It should be understood that liquids, beverages and other beverage products in accordance with this disclosure may have any of numerous different specific formulations or constitutions. The formulation of a beverage product in accordance with this disclosure may vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below. Additional (i.e., more and/or other) sweeteners may be added, flavorings, electrolytes, vitamins, fruit juices or other fruit products, tastents, masking agents and the like, flavor enhancers, and/or carbonation typically may be added to any such formulations to vary the taste, mouthfeel, nutritional characteristics, etc. In general, a beverage in accordance with this disclosure typically comprises at least water, sweetener, acidulant and flavoring. Exemplary flavorings which may be suitable for at least certain formulations in accordance with this disclosure include cola flavoring, citrus flavoring, spice flavorings and others. Carbonation in the form of carbon dioxide may be added for effervescence. Preservatives may be added if desired, depending upon the other ingredients, production technique, desired shelf life, etc. Optionally, caffeine may be added. Certain exemplary embodiments of the beverages disclosed here are cola-flavored carbonated beverages, characteristically containing carbonated water, sweetener, kola nut extract and/or other flavoring, caramel coloring, phosphoric acid, and optionally other ingredients. Additional and alternative suitable ingredients will be recognized by those skilled in the art given the benefit of this disclosure.

The beverage products disclosed here include beverages, i.e., ready-to-drink liquid formulations, beverage concentrates and the like. As used herein, the term “ready-to-drink” refers to a beverage that can be ingested as-is. That is, the ready-to-drink beverage requires no dilution or additions prior to ingestion by a consumer. Beverage products include, e.g., carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, and alcoholic products.

In certain exemplary embodiments of the ready-to-drink beverages disclosed here, the sweetener comprises at least about 100 ppm, about 200 ppm, about 300 ppm, about 400 ppm or about 500 ppm rebaudioside D. In certain exemplary embodiments of the ready-to-drink beverages disclosed here, the sweetener comprises between about 300 ppm and about 700 ppm, between about 350 ppm and about 650 ppm, between about 400 ppm and about 600 ppm, or between 450 ppm and about 550 ppm rebaudioside D.

The terms “beverage concentrate,” “throw beverage syrup” and “syrup” are used interchangeably throughout this disclosure. At least certain exemplary embodiments of the beverage concentrates contemplated are prepared with an initial volume of water to which the additional ingredients are added. A single strength beverage composition (i.e., a beverage composition at a concentration that is ready to drink) may be formed from the beverage concentrate or syrup by adding further volumes of water to the concentrate to dilute it to a single strength. Typically, for example, single strength beverages may be prepared from the concentrates by combining approximately 1 part concentrate with between approximately 3 to approximately 7 parts water. In certain exemplary embodiments the single strength beverage is prepared by combining 1 part concentrate with 5 parts water. In certain exemplary embodiments the additional water used to form the single strength beverages is carbonated water. In certain other embodiments, a single strength beverage is directly prepared without the formation of a concentrate and subsequent dilution.

As used here and in the appended claims, “sweetened syrup” is defined as syrup that possesses sweetness, and comprises at least one or more sweeteners. In certain exemplary embodiments of the sweetened syrups disclosed here, the sweetener comprises at least rebaudioside D. In certain exemplary embodiments of the sweetened syrups disclosed here, the sweetener comprises at least about 1000 ppm, about 1500 ppm, about 2000 ppm, about 2500 ppm, about 3000 ppm, about 3500 ppm, about 4000 ppm, about 4500 ppm or about 5000 ppm rebaudioside D.

Natural embodiments of the beverage products disclosed here are natural in that they do not contain anything artificial or synthetic (including any color additives regardless of source) that would not normally be expected to be in the food. As used herein, therefore, a “natural” beverage composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately.

Substantially clear embodiments of the beverage products disclosed here are substantially clear in that the beverages have substantially no turbidity and substantially no color.

Water is a basic ingredient in the beverage products disclosed here, typically being the vehicle or primary liquid portion in which the supersaturated rebaudioside D is provided and the remaining ingredients are dissolved, emulsified, suspended or dispersed. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain typical embodiments, water is present at a level of from about 80% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,” “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

The steviol glycosides include, e.g., rebaudiosides, such as rebaudioside D, stevioside, and related compounds for sweetening. These compounds may be obtained by extraction or the like from the stevia plant. Stevia (e.g., Stevia rebaudiana bectoni) is a sweet-tasting plant. The leaves contain a complex mixture of natural sweet diterpene glycosides. Steviol glycosides and rebaudiosides are components of Stevia that contribute sweetness. Typically, these compounds are found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). The following non-sweet constituents also have been identified in the leaves of stevia plants: labdane, diterpene, triterpenes, sterols, flavonoids, volatile oil constituents, pigments, gums and inorganic matter. Generally, the beverage products disclosed herein may include at least one steviol glycoside, for example, rebaudioside A, rebaudioside B, rebaudioside C, rebaudioside D, rebaudioside E, stevioside, steviolbioside, dulcoside A, a Stevia rebaudiana extract, or mixtures of any of them.

The at least one edible acid used in the beverages products disclosed herein may serve any one or more of several functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids suitable for use in some or all embodiments of the beverage products disclosed here include phosphoric acid, citric acid, malic acid, tartaric acid, lactic acid, fumaric acid, ascorbic acid, gluconic acid, succinic acid, maleic acid, adipic acid, cinnamic acid, glutaric acid, and mixtures of any of them. Typically, the acid is phosphoric acid, citric acid, malic acid, or combinations thereof such as phosphoric acid and citric acid.

Titratable acidity is an indication of the total acidity of a beverage product. Titratable acidity measures the amount of alkali required to neutralize the acid of a given volume of beverage. The titratable acidity is the millimeter of 0.1 N NaOH required to titrate 100 ml of beverage to a pH 8.75 end point with a potentiometer. The titratable acidity of the beverage product comprising rebaudioside A, erythritol, and at least one acid is typically about 8.75 to about 10.5, or from about 9 to about 10. Suitable titratable acidities include, e.g., about 9, 9.25, 9.5, 9.75, 10, or 10.25.

The acid may be used in solution form, for example, and in an amount sufficient to provide the desired pH of the beverage. The particular acid or acids chosen and the amount used will depend, in part, on the other ingredients, the desired shelf life of the beverage product, as well as effects on the beverage pH, titratable acidity, and taste. Typically, for example, the one or more acids of the acidulant are used in an amount, collectively, of from about 0.01% to about 1.0% by weight of the beverage, e.g., from about 0.01% to about 0.5% by weight, from about 0.05% to about 0.5% by weight, from about 0.05% to about 0.25% by weight, from about 0.1% to about 0.25% by weight, depending upon the acidulant used, desired pH, other ingredients used, etc. The pH of at least certain exemplary embodiments of the beverages disclosed here may be a value within the range of from about 2.0 to 5.0, about 2.5 to 4.0, about 2.8 to 3.3 or about 3.0 to 3.2., e.g., 3.1. The acid in certain exemplary embodiments enhances beverage flavor. Too much acid may impair the beverage flavor and result in tartness or other off-taste, while too little acid may make the beverage taste flat.

Those skilled in the art, given the benefit of this disclosure, will recognize that when preparing beverage products containing sweeteners in addition to the steviol glycoside such as peptide-based artificial sweeteners such as aspartame, the resulting beverage composition is best maintained below a certain pH to retain the sweetening effect of the artificial sweetener. In the formation of calcium-supplemented beverages, the presence of calcium salts increases the pH which requires additional acids to both assist the dissolution of the salt and maintain a desirable pH for stability of the artificial sweetener. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverage products disclosed here.

In addition to rebaudioside D, optionally additional sweetener may be used in the beverage product disclosed herein. Such optional additional sweeteners suitable for use in various exemplary embodiments of beverage products comprising rebaudioside D include natural and artificial or synthetic sweeteners. Suitable sweeteners and combinations of sweeteners are selected for the desired nutritional characteristics, taste profile for the beverage, mouthfeel and other organoleptic factors. As used herein, “taste” refers to a combination of sweetness perception, temporal effects of sweetness perception, i.e., on-set and duration, off-tastes, e.g. bitterness and metallic taste, residual perception (aftertaste) and tactile perception, e.g. body and thickness. As used herein, a “full-calorie” beverage formulation is one fully sweetened with a nutritive sweetener. The term “nutritive sweetener” refers generally to sweeteners which provide significant caloric content in typical usage amounts, e.g., more than about 5 calories per 8 oz. serving of beverage. As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage sweetened to a level of 10 degrees Brix with sugar. Potent sweeteners include both nutritive (e.g., Lo Han Guo juice concentrate) and non-nutritive sweeteners (e.g., typically, Lo Han Guo powder). In addition, potent sweeteners include both natural potent sweeteners (e.g., steviol glycosides, Lo Han Guo, etc.) and artificial potent sweeteners (e.g., neotame, etc.). However, for natural beverage products disclosed here, only natural potent sweeteners are employed. Commonly accepted potency figures for certain potent sweeteners include, for example,

| | |
|---|---|
| Cyclamate | 30 times as sweet as sugar |
| Stevioside | 100-250 times as sweet as sugar |
| Mogroside V | 100-300 times as sweet as sugar |
| Rebaudioside A | 150-300 times as sweet as sugar |
| Rebaudioside D | 150-300 times as sweet as sugar |
| Acesulfame-K | 200 times as sweet as sugar |
| Aspertame | 200 times as sweet as sugar |
| Saccharin | 300 times as sweet as sugar |
| Neohesperidin dihydrochalcone | 300 times as sweet as sugar |
| Sucralose | 600 times as sweet as sugar |
| Neotame | 8,000 times as sweet as sugar |

Sweeteners suitable for at least certain exemplary embodiments include, for example, sugar alcohols such as sorbitol, mannitol, xylitol, lactitol, isomalt, and malitol. Other sweeteners include tagatose, e.g., D-tagatose, and combinations of tagatose with the sugar alcohol erythritol.

As further discussed below, exemplary natural nutritive sweeteners suitable for some or all embodiments of the beverage products disclosed here include crystalline or liquid sucrose, fructose, glucose, dextrose, maltose, trehalose, fructo-oligosaccharides, glucose-fructose syrup from natural sources such as apple, chicory, honey, etc., e.g., high fructose corn syrup, invert sugar and the like and mixtures of any of them; exemplary artificial sweeteners suitable for some or all embodiments of the beverages disclosed here include saccharin, cyclamate, aspartame, other dipeptides, acesulfame potassium, and other such potent sweeteners, and mixtures of any of them; and exemplary natural non-nutritive potent sweeteners suitable for some or all embodiments of the beverages including rebaudioside D disclosed here include steviol glycosides (e.g., stevioside, steviolbioside, dulcoside A, rebaudioside A, rebaudioside B, rebaudioside C, rebaudioside E, mixtures of any of them, etc.) and Lo Han Guo and related compounds, and mixtures of any of them. Lo Han Guo is a potent sweetener which can be provided as a natural nutritive or natural non-nutritive sweetener. For example, Lo Han Guo juice concentrate may be a nutritive sweetener, and Lo Han Guo powder may be a non-nutritive sweetener. Also, in at least certain exemplary embodiments of the beverages disclosed here, combinations of one or more natural nutritive sweeteners, one or more artificial sweeteners and/or one or more natural non-nutritive potent sweeteners are used to provide the sweetness and other aspects of desired taste profile and nutritive characteristics. It should also be recognized that certain such sweeteners will, either in addition or instead, act as tastents, masking agents or the like in various embodiments of the beverages disclosed here, e.g., when used in amounts below its (or their) sweetness perception threshold in the beverage in question.

The sweeteners included in the formulations of the beverage products disclosed here are edible consumables suitable for consumption and for use in beverages. By “edible consumables” is meant a food or beverage or an ingredient of a food or beverage for human or animal consumption. The sweetener or sweetening agent used here and in the claims may be a nutritive or non-nutritive, natural or synthetic beverage ingredient or additive (or mixtures of them) which provides sweetness to the beverage, i.e., which is perceived as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent may involve the interrelationship of elements.

In at least certain exemplary embodiments of beverage products comprising rebaudioside A, erythritol, and at least one acid disclosed here, the sweetener component may include as an optional additional sweetener, nutritive, natural crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others. Such sweeteners are present in at least certain exemplary embodiments in an amount of from about 0.1% to about 20% by weight of the beverage, such as from about 6% to about 16% by weight, depending upon the desired level of sweetness for the beverage. To achieve desired beverage uniformity, texture and taste, in certain exemplary embodiments of the natural beverage products disclosed here, standardized liquid sugars as are commonly employed in the beverage industry can be used. Typically such standardized sweeteners are free of traces of non-sugar solids which could adversely affect the flavor, color or consistency of the beverage.

The term “nutritive sweetener” refers generally to sweeteners which provide significant caloric content in typical usage amounts, e.g., more than about 5 calories per 8 oz. serving of beverage. As used herein, a “full-calorie” beverage formulation is one fully sweetened with a nutritive sweetener. As used herein, a “non-nutritive sweetener” is one which does not provide significant caloric content in typical usage amounts, i.e., is one which imparts less than 5 calories per 8 oz. serving of beverage to achieve the sweetness equivalent of 10 Brix of sugar. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz. serving of beverage. As used herein, “zero-calorie” or “diet” means having less than 5 calories per serving, e.g., per 8 oz. for beverages.

Artificial and natural non-nutritive potent sweeteners are suitable for use in at least certain exemplary embodiments of the beverages comprising at least one steviol glycoside and at least one acid disclosed here. Such artificial potent sweeteners include peptide based sweeteners, for example, aspartame, neotame, and alitame, and non-peptide based sweeteners, for example, sodium saccharin, calcium saccharin, acesulfame potassium, sodium cyclamate, calcium cyclamate, neohesperidin dihydrochalcone, and sucralose. Alitame may be less desirable for caramel-containing beverages where it has been known to form a precipitate. In certain exemplary embodiments the beverage product employs aspartame as the sweetener, either alone or with other sweeteners. In certain other exemplary embodiments the sweetener comprises aspartame and acesulfame potassium. The natural non-nutritive potent sweeteners include, for example, steviol glycosides (e.g., stevioside, steviolbioside, dulcoside A, rebaudioside A, rebaudioside B, rebaudioside C, rebaudioside D, rebaudioside E, mixtures of any of them, etc.), Lo Han Guo and related compounds, as discussed further below. Non-nutritive, high potency sweeteners typically are employed at a level of milligrams per fluid ounce of beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use in various embodiments of the beverage products disclosed here.

The sweetener Lo Han Guo, which has various different spellings and pronunciations, may be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Luo Han fruit. Lo Han Guo contains triterpene glycosides or mogrosides, which constituents may be used as Lo Han Guo sweeteners. Luo Han Guo may be used as the juice or juice concentrate, powder, etc. LHG juice concentrate may contain about 3 wt. % to about 12 wt. %, e.g., about 6 wt. % mogrosides, such as mogroside V, mogroside IV, (11-oxo-mogroside V), siamenoside and mixtures thereof. Lo Han Guo may be produced, for example, as discussed in U.S. Pat. No. 5,411,755. Sweeteners from other fruits, vegetables or plants also may be used as natural or processed sweeteners or sweetness enhancers in at least certain exemplary embodiments of the beverages disclosed here.

Other exemplary sweeteners include glycyrrhizin, neohesperidin dihydrochalcone, lactose, xylose, arabinose and ribose, and protein sweeteners such as thaumatin, monatin, monellin, brazzein, L-alanine and glycine.

Certain exemplary embodiments of the beverage products disclosed here also may contain small amounts of alkaline agents to adjust pH. Such agents include, e.g., potassium citrate and sodium citrate. For example, the alkaline agent potassium hydroxide may be used in an amount of from about 0.005 wt. % to about 0.02 wt. % (by weight of the beverage), with an amount of about 0.01% being typical for certain beverages. The amount will depend, of course, on the type of alkaline agents and on the degree to which the pH is to be adjusted.

The beverage products disclosed here optionally contain a flavor composition, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime grapefruit, tangerine, mandarin orange, tangelo, and pomelo, and such flavors as apple, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors may include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component may further comprise a blend of several of the above-mentioned flavors. In certain exemplary embodiments of the beverage concentrates and beverages a cola flavor component is used or a tea flavor component. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices may be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices may be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin and grapefruit etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.2% by weight of the beverage. In certain exemplary embodiments juice is employed at a level of from about 0.2% to about 40% by weight of the beverage. Typically, juice may be used, if at all, in an amount of from about 1% to about 20% by weight.

Certain such juices which are lighter in color may be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices may be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings may be in the form of an extract, oleoresin, juice concentrate, bottler's base, or other forms known in the art. In at least certain exemplary embodiments, such spice or other flavors complement that of a juice or juice combination.

The one or more flavorings may be used in the form of an emulsion. A flavoring emulsion may be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide is used to provide effervescence to certain exemplary embodiments of the beverages disclosed here. Any of the techniques and carbonating equipment known in the art for carbonating beverages may be employed. Carbon dioxide may enhance the beverage taste and appearance and may aid in safeguarding the beverage purity by inhibiting and destroying objectionable bacteria. In certain embodiments, for example, the beverage has a CO₂ level up to about 4.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of liquid, e.g., water at 60° F. (16° C.) and one atmospheric pressure. A volume of gas occupies the same space as does the liquid by which it is dissolved. The carbon dioxide content may be selected by those skilled in the art based on the desired level of effervescence and the impact of the carbon dioxide on the taste or mouthfeel of the beverage. The carbonation may be natural or synthetic.

Optionally, caffeine may be added to various embodiments of the beverages disclosed here. The amount of caffeine added is determined by the desired beverage properties, any applicable regulatory provisions of the country where the beverage is to be marketed, etc. In certain exemplary embodiments caffeine is included at a level of 0.02 percent or less by weight of the beverage. The caffeine must be of purity acceptable for use in foods and beverages. The caffeine may be natural or synthetic in origin.

The beverage concentrates and beverages disclosed here may contain additional ingredients, including, generally, any of those typically found in beverage formulations. These additional ingredients, for example, may typically be added to a stabilized beverage concentrate. Examples of such additional ingredients include, but are not limited to, caffeine, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B (thiamine), B₂ (riboflavin), B₆, B₁₂, and K, niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

Preservatives may be used in at least certain embodiments of the beverages disclosed here. That is, at least certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system may be used if desired. If a preservative system is used, it may be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the beverage products disclosed here include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

The following examples are specific embodiments of the present invention but are not intended to limit it.

### Example I

### Physical Properties of Rebaudioside D

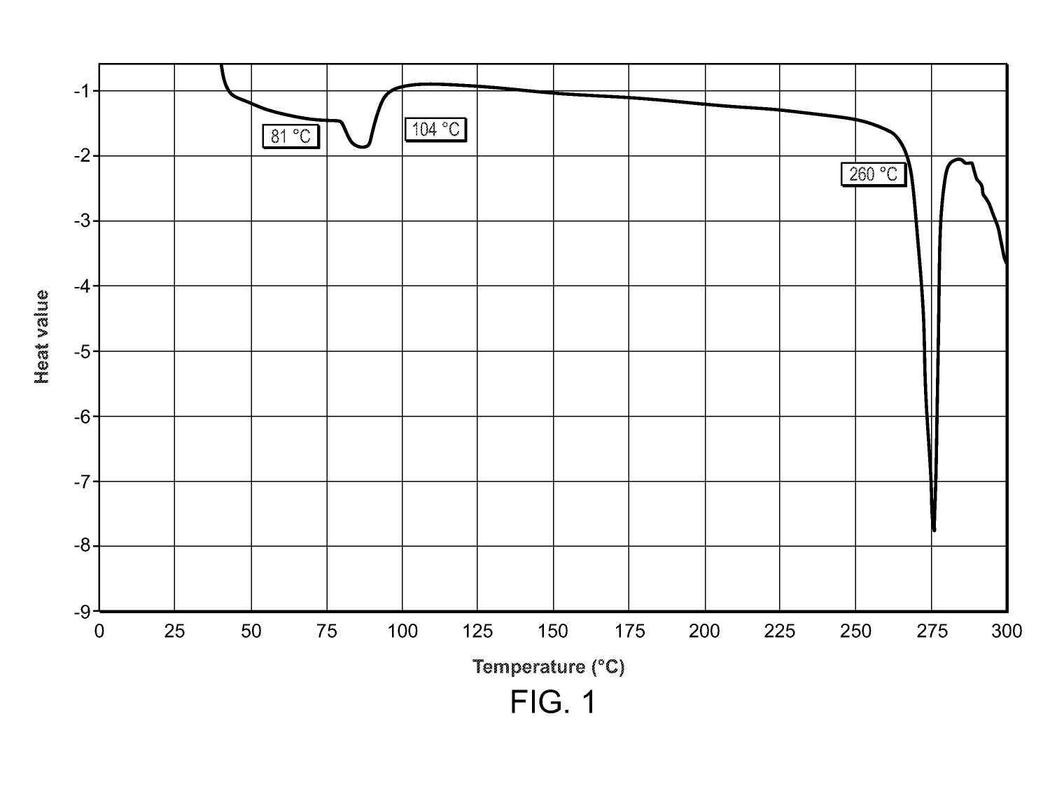

Differential scanning calorimetry (DSC) was used to determine if any phase changes occurred in rebaudioside D as it was heated. A sample of rebaudioside D was heated in a controlled environment and heat gains or losses were measured as a function of temperature. As illustrated in FIG. 1, DSC analysis of rebaudioside D was carried out between 40°-300° C. with heating at 10° C./min. The results indicate a thermal energy change (i.e., an endothermic heat event) beginning at about 80° C. and ending at about 104° C. which, without intending to be bound by scientific theory, is related to a drastic increase in rebaudioside A solubility at that temperature.

Surprisingly, it has been determined that a significant, i.e., approximately 20-fold, increase in the solubility of rebaudioside D in water occurs at about 80° C. At 20° C., Rebaudioside D has a solubility of about 0.03% (w/w) in water, and the solubility was determined to gradually increase between 60° C. and 70° C. At about 80° C., however a significant jump in solubility occurred. At this temperature, rebaudioside D had a solubility of 0.6% (w/w) in water.

The discovery that rebaudioside D becomes much more soluble in water at 80° C. relative to its solubility at lower temperatures provides a variety of advantages. One such advantage is that existing commercial beverage production and/or bottling plants can be used to make beverage products including rebaudioside D as only a heating unit would need to be added to such plants. Another advantage is energy savings should be achieved given the fact that rebaudioside D does not need to be heated to boiling in order for it to become soluble at concentrations useful for the beverage products described herein. Other advantages would be readily apparent to those of skill in the art given the benefit of this disclosure.

### Example II

### Rebaudioside D Solubility Study

### Objective

To test the solubility of rebaudioside D at different concentrations and determine the solubility limits. Specifically, to test solubility of rebaudioside D at different concentrations at ambient temperature; determine if heat increases solubility of rebaudioside D; determine solubility limit of rebaudioside D; observe saturated solution after it cools to ambient temperature and watch for recrystallization; and determine if high shear mixing increases solubility.

### Materials

Rebaudioside D, precision balance, R-O Water, 100 ml beakers, 4 L beakers, admix mixer, Rotosolver disperser, heater-stirrers, magnetic stir bars, thermometers, weigh boats, stainless steel spatula, timers.

### Description of Experiments

Several different experimental setups were used to determine the solubility of rebaudioside D.

### Experiment 1

The sweetener was added to ambient temperature R-O water ((˜20° C.) at different concentrations starting at 0.03% and ending at 0.10%). The solutions were agitated, using a magnetic stirrer, to first observe solubility of the sweetener with agitation; if sweetener did not dissolve within a 45 minute timeframe, agitation was terminated. The solutions were left at ambient temperature for 3 days to observe possible recrystallization of dissolved sweetener.

At low concentrations, total weight of sweetener was added to water. At high concentrations, sweetener was added partially over time.

### Experiment 2

The second experiment introduced heat. Higher concentrations were tested. The solutions were heated to 80° C. and agitated using a magnetic stirrer. The solubility limit for this temperature was also tested. Another test was preformed to observe recrystallization. After the sweetener had been dissolved, the solutions were left to cool down to ambient temperature and were observed for 3 days. Recrystallization, if any, was recorded.

### Experiment 3

The third experiment was preformed using a high shear mixer set at 850 rpm. A 0.60% solution was sheared for 30 minutes, using an Admix high shear mixer with the Rotosolver disperser, at ambient temperature. Another 0.60% solution was initially heated to 80° C. and sheared for 45 minutes without the presence of heat.

### Results and Discussion

### Experiment 1

TABLE 1
Results for Experiment 1.

| Concentration | Day 1 | Day 2 | Day 3 |
|---|---|---|---|
| 0.03% | Clear; dissolved | Solution clear; no solids | Solution clear; no solids |
| | completely | | |
| 0.05% | Clear; some solids | Solution clear; tiny | Solution clear; tiny |
| | remained on the bottom | amount of solids on | amount of solids on |
| | | bottom | bottom |
| 0.07% | Hazy; solids on the | Solution less hazy; increase | Solution mostly clear; |
| | bottom | in solids on bottom | more solids on bottom |
| 0.10% | Hazy; solids on the | Solution less hazy; many | Solution mostly clear; |
| | bottom | solids on bottom | many solids on bottom |

At 0.03%, rebaudioside D completely dissolved with agitation and remained in solution for the total 3 day time frame. At 0.05%, the sweetener mostly dissolved with agitation; the undissolved sweetener concentration remained constant within the 3 day timeframe. At 0.07% and 0.10%, a negligible amount of rebaudioside D dissolved with agitation; the undissolved sweetener concentration remained constant within the 3 day time frame.

### Experiment 2

TABLE 2
Results for Experiment 2.

| Concentration | Day 1 | Day 2 | Day 3 |
|---|---|---|---|
| 0.07% | Clear; no solids | Clear; no solids | Clear; no solids |
| 0.10% | Clear; no solids | Clear; no solids | Clear; no solids |
| 0.20% | Clear; no solids | Clear; some solids | Clear; many |
| | | | solids |

TABLE 3
Results for Experiment 2, cont'd.

| Concentration | Day 1 | Day 2 | Day 3 |
|---|---|---|---|
| 0.12% | Clear; no solids | Clear; no solids | Clear; no solids |
| 0.14% | Clear; no solids | Clear; no solids | Clear; no solids |
| 0.16% | Clear; no solids | Clear; no solids | Clear; no solids |
| 0.18% | Clear; no solids | Clear; no solids | Clear; no solids |

Heating the solution greatly increased the amount of sweetener that could be dissolved. At concentrations below 0.20%, the dissolved sweetener remained in solution for the 3 day timeframe. At 0.20%, recrystallization occurred on day 2 and increased over time.

Surprisingly, it was discovered that a 0.60% rebaudioside D solution could be obtained with temperatures at or above 80° C. The recrystallization time for a 0.60% was found to be less than one hour. Solutions at lower concentrations took longer to recrystallize. A 0.30% sweetener solution made from a 0.60% solution, had a precipitation time of approximately 9 hours.

### Experiment 3

The ambient temperature solution remained in solid phase. The sweetener dissolved with heat, but after heat was removed, the solution recrystallized despite high shear mixing.

### CONCLUSION

At ambient temperature with initial agitation, the sweetener had low solubility at concentrations between 0.05% and 0.10%. Below 0.05%, solubility increased.

Heating the mixture increased the solubility but solubility still remained somewhat low. Solubility greatly increased with temperatures above 80° C. While maintaining a temperature of 80° C., a 0.60% concentration could be obtained. However, the recrystallization time for a solution at this concentration was less than 1 hour. As the concentration decreased, the recrystallization time increased.

High shear mixing at high concentrations, without constant heat, proved to have little or no effect.

### HPLC Analysis

The results of two high performance liquid chromatography (HPLC) analyses preformed on a series of three different rebaudioside D solutions are described below. Two sets of triplicate samples were submitted at different times.

The first set of samples was prepared as follows:
A. Reb-D 0.03% aqueous-prepared at ambient temperature (control)
B. Reb-D 0.03% prepared in dilute aqueous H₃PO₄ (pH 3)
C. Reb-D 0.03% initially prepared at 0.60% with heat and diluted 1:20 with water

### Results

| Sample | [Reb D], mg/L* |
|---|---|
| A1 | 296.2 ± 1.6 |
| A2 | 288.1 ± 1.4 |
| A3 | 288.5 ± 2.5 |
| B1 | 293.5 ± 2.2 |
| B2 | 289.0 ± 2.3 |
| B3 | 285.5 ± 2.1 |
| C1 | 292.9 ± 1.5 |
| C2 | 292.0 ± 3.1 |
| C3 | 221.2 ± 2.2 |

The second set of samples was prepared as follows
A. Reb-D 0.03% aqueous-prepared at ambient temperature (control)
B. Reb-D 0.03% prepared in dilute aqueous H₃PO₄ (pH 2.6)
C. Reb-D 0.03% initially prepared at 0.60% with heat and diluted 1:20 with water

| Sample | [Reb D], mg/L* |
|---|---|
| A1 | 275.8 ± 3.8 |
| A2 | 262.5 ± 1.9 |
| A3 | 278.1 ± 0.5 |
| B1 | 266.4 ± 1.8 |
| B2 | 284.8 ± 3.3 |
| B3 | 278.9 ± 1.5 |
| C1 | 281.8 ± 1.7 |
| C2 | 282.3 ± 2.7 |
| C3 | 284.9 ± 2.4 |

Those of ordinary skill in the art will understand that, for convenience, some ingredients are described here in certain cases by reference to the original form of the ingredient in which it is used in formulating or producing the beverage product. Such original form of the ingredient may differ from the form in which the ingredient is found in the finished beverage product. Thus, for example, in certain exemplary embodiments of the beverage products according to this disclosure, sucrose and liquid sucrose would typically be substantially homogenously dissolved and dispersed in the beverage. Likewise, other ingredients identified as a solid, concentrate (e.g., juice concentrate), etc. would typically be homogeneously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A method of preparing a supersaturated solution of rebaudioside D comprising the steps of:
a) mixing rebaudioside D in aqueous liquid with heating to an elevated temperature to form a heated rebaudioside D solution having a pH of at least 7.0;
b) cooling the rebaudioside D solution to form a supersaturated solution of rebaudioside D;
c) adding at least one beverage ingredient to the supersaturated solution of rebaudioside D to form a beverage product precursor having a pH of at least 7.0; and
d) acidulating the beverage product precursor to a pH of less than 4.0.

2. The method of claim 1, wherein the heated rebaudioside D solution in step (a) is at least 80° C.

3. The method of claim 1, wherein the heated rebaudioside D solution in step (a) is between 75° C. and 90° C.

4. The method of claim 1, wherein the heated rebaudioside D solution in step (a) is between 80° C. and 85° C.

5. The method of claim 1, wherein the mixing is at least in part concurrent with the heating.

6. The method of claim 1, wherein the mixing comprises high shear stirring.

7. The method of claim 1, wherein the concentration of rebaudioside D in the supersaturated solution of rebaudioside D is at least 500 parts per million (ppm).

8. The method of claim 1, wherein the concentration of rebaudioside D in the supersaturated solution of rebaudioside D is at least 3000 ppm.

9. The method of claim 1, wherein the rebaudioside D concentration in the heated rebaudioside D solution is at least 90% of the solubility limit for rebaudioside D in water at the elevated temperature.

10. The method of claim 1, wherein the step of acidulating the beverage product precursor comprises adding at least one edible acid to the beverage product precursor.

11. The method of claim 10, wherein the at least one edible acid is selected from the group consisting of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them.

12. The method of claim 1, further comprising carbonating the beverage product precursor.

13. The method of claim 1, wherein the step of cooling is performed at a rate of 5° C./hour.

14. A method of preparing a syrup comprising the steps of:
a) mixing rebaudioside D in aqueous liquid with heating to an elevated temperature to form a heated rebaudioside D solution having a pH of at least 7.0;
b) cooling the rebaudioside D solution to form a supersaturated solution of rebaudioside D;
c) adding at least one syrup ingredient to the supersaturated solution of rebaudioside D to form a syrup precursor having a pH of at least 7.0; and
d) acidulating the syrup precursor to a pH of less than 4.0.

15. The method of claim 14, wherein the heated rebaudioside D solution in step (a) is at least 80° C.

16. The method of claim 14, wherein the heated rebaudioside D solution in step (a) is between 75° C. and 90° C.

17. The method of claim 14, wherein the heated rebaudioside D solution in step (a) is between 80° C. and 85° C.

18. The method of claim 14, wherein the mixing is at least in part concurrent with the heating.

19. The method of claim 14, wherein the mixing comprises high shear stirring.

20. The method of claim 14, wherein the concentration of rebaudioside D in the syrup is at least 3000 ppm.

21. The method of claim 14, wherein the step of acidulating the syrup precursor comprises adding at least one edible acid to the beverage product precursor.

22. The method of claim 21, wherein the at least one edible acid is selected from the group consisting of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them.

23. The method of claim 14, wherein the step of cooling is performed at a rate of 5° C./hour.

24. The method of claim 14, wherein the at least one syrup ingredient is selected from the group consisting of a flavorant, a colorant, a preservative and mixtures of any of them.

25. A method of preparing a ready-to-drink, low pH beverage, comprising the steps of:
a) mixing rebaudioside D in aqueous liquid with heating to an elevated temperature to form a heated rebaudioside D solution having a pH of at least 7.0;
b) cooling the rebaudioside D solution to form a supersaturated solution of rebaudioside D;
c) adding multiple beverage ingredients to the supersaturated solution of rebaudioside D to form a beverage product precursor having a pH of at least 7.0;
d) acidulating the beverage product precursor to a pH less than 4.0; and
e) diluting the beverage product precursor to form a ready-to-drink, low pH beverage.

26. The method of claim 25, wherein the heated rebaudioside D solution in step (a) is at least 80° C.

27. The method of claim 25, wherein the heated rebaudioside D solution in step (a) is between 75° C. and 90° C.

28. The method of claim 25, wherein the heated rebaudioside D solution in step (a) is between 80° C. and 85° C.

29. The method of claim 25, wherein the mixing is at least in part concurrent with the heating.

30. The method of claim 25, wherein the mixing comprises high shear stirring.

31. The method of claim 25, wherein the concentration of rebaudioside D in the ready-to-drink, low pH beverage is at least 400 ppm.

32. The method of claim 25, wherein the concentration of rebaudioside D in the ready-to-drink, low pH beverage is between 450 ppm and 500 ppm.

33. The method of claim 25, wherein the step of acidulating the beverage product precursor comprises adding at least one edible acid to the beverage product precursor.

34. The method of claim 33, wherein the at least one edible acid is selected from the group consisting of citric acid, phosphoric acid, malic acid, tartaric acid, lactic acid, fumaric acid, ascorbic acid, gluconic acid, succinic acid, maleic acid, adipic acid, cinnamic acid, glutaric acid and mixtures of any of them.

35. The method of claim 25, wherein the step of cooling is performed at a rate of 5° C./hour.

36. The method of claim 25, further comprising the step of:
f) carbonating the low pH beverage to produce a carbonated, ready-to-drink, low pH beverage.

37. The method of claim 25, further comprising the step of:
f) filling multiple containers with the low pH beverage.

38. The method of claim 36, further comprising the step of:
g) filling multiple containers with the carbonated, low pH beverage.

39. The method of claim 25, wherein the ready-to-drink, low pH beverage is selected from the group consisting of a carbonated soft drink, a non-carbonated soft drink and a fountain drink.
